(19) United States
(12) Patent Application Publication
(10) Pub. No.: US 2014/0312605 A1
(43) Pub. Date: Oct. 23, 2014

(54) BOOKMARK

(71) Applicant: Manal Rabba, Ontario (CA)

(72) Inventor: Manal Rabba, Ontario (CA)

(21) Appl. No.: 14/259,631

(22) Filed: Apr. 23, 2014

Related U.S. Application Data
(60) Provisional application No. 61/814,999, filed on Apr. 23, 2013.

(51) Int. Cl. B42D 9/00; A44B 18/00

(52) U.S. Cl. CPC B42D 9/007; A44B 18/0069
USPC 281/42

(57) ABSTRACT

An apparatus is provided for use with a plurality of pages and a pair of covers, the pages and covers being bound together to define a book. The apparatus comprises a strap and a pair of hook and loop fasteners. One of the pair of hook and loop fasteners is disposed on one of the faces and adjacent one of the ends; the other of the pair is disposed on the other of the faces and adjacent the other of the ends. The strap permits, when it is desired to bookmark a location in the book, the strap to be wrapped around one of the portions and the hook and loop fasteners to be releasably engaged together, whereby the one of the portions is grippingly received by the strap and the location is marked.

### RELATED APPLICATIONS

This application is a non-provisional application that claims priority benefit of U.S. Provisional Application Ser. No. 61/814,999 filed 23 Apr. 2013; the contents of which are hereby incorporated by reference.

### FIELD OF THE INVENTION

The invention relates to the field of bookmarks.

### BACKGROUND OF THE INVENTION

A bookmark is a thin marker used to keep the reader's place in a book and to enable the reader to return to it with ease. Frequently used materials for bookmarks include card stock, fabric, leather, metals, silk, wood and cord. Many bookmarks can be clipped on a page with the aid of a page-flap.

### SUMMARY OF THE INVENTION

Forming one aspect of the invention is apparatus for use with a plurality of pages and a pair of covers, the pages and covers being bound together to define a book. The apparatus comprises a strap and a pair of hook and loop fasteners. The strap has a thickness, a width greater than the thickness, a length greater than the width, a pair of ends spaced-apart lengthwise from one another and a pair of faces spaced apart a distance defined by the thickness. One of the pair of hook and loop fasteners is disposed on one of the faces and adjacent one of the ends; the other of the pair is disposed on the other of the faces and adjacent the other of the ends. The strap is shaped and sized and the pair of hook and loop fasteners are shaped, sized and positioned to permit, when it is desired to bookmark a location in the book and thereby notionally divide the book into two portions, each including a respective one of the covers and a respective portion of the plurality of pages, the strap to be wrapped around one of the portions and the hook and loop fasteners to be releasably engaged together, whereby the one of the portions is grippingly received by the strap and the location is marked.

According to another aspect of the invention, the length can be about 21.5 inches, the one of the hook and loop fasteners can be about 7 inches in length and the other of the hook and loop fasteners can be about 1 inch in length.

According to another aspect of the invention, the length can be about 27.5 inches, the one of the hook and loop fasteners can be about 7 inches in length and the other of the hook and loop fasteners can be about 1 inch in length.

According to another aspect of the invention, the length can be about 29.5 inches, the one of the hook and loop fasteners can be about 9 inches in length and the other of the hook and loop fasteners can be about 1 inch in length.

According to another aspect of the invention, the length can be about 15.5 inches, the one of the hook and loop fasteners can be about 5 inches in length and the other of the hook and loop fasteners can be about 1 inch in length.

According to another aspect of the invention, the width can be between about 1 and 2 inches.

According to another aspect of the invention, the strap can be constructed from twill tape.

Other advantages, features and characteristics of the present invention will become apparent upon consideration of the following detailed description of an exemplary embodiment of the invention which makes reference to the appended drawings, the latter being briefly described hereinafter.

### BRIEF DESCRIPTION OF THE DRAWINGS

FIG. 1 is a front view of apparatus according to the exemplary embodiment of the invention;

FIG. 2 is a rear view of the apparatus of FIG. 1;

FIG. 3 is a side view of the apparatus of FIG. 1;

FIG. 4 is a view of the structure of FIG. 1 in use; and

FIG. 5 is a view of the structure of FIG. 4, from a different vantage point.

### DETAILED DESCRIPTION OF THE EXEMPLARY EMBODIMENT

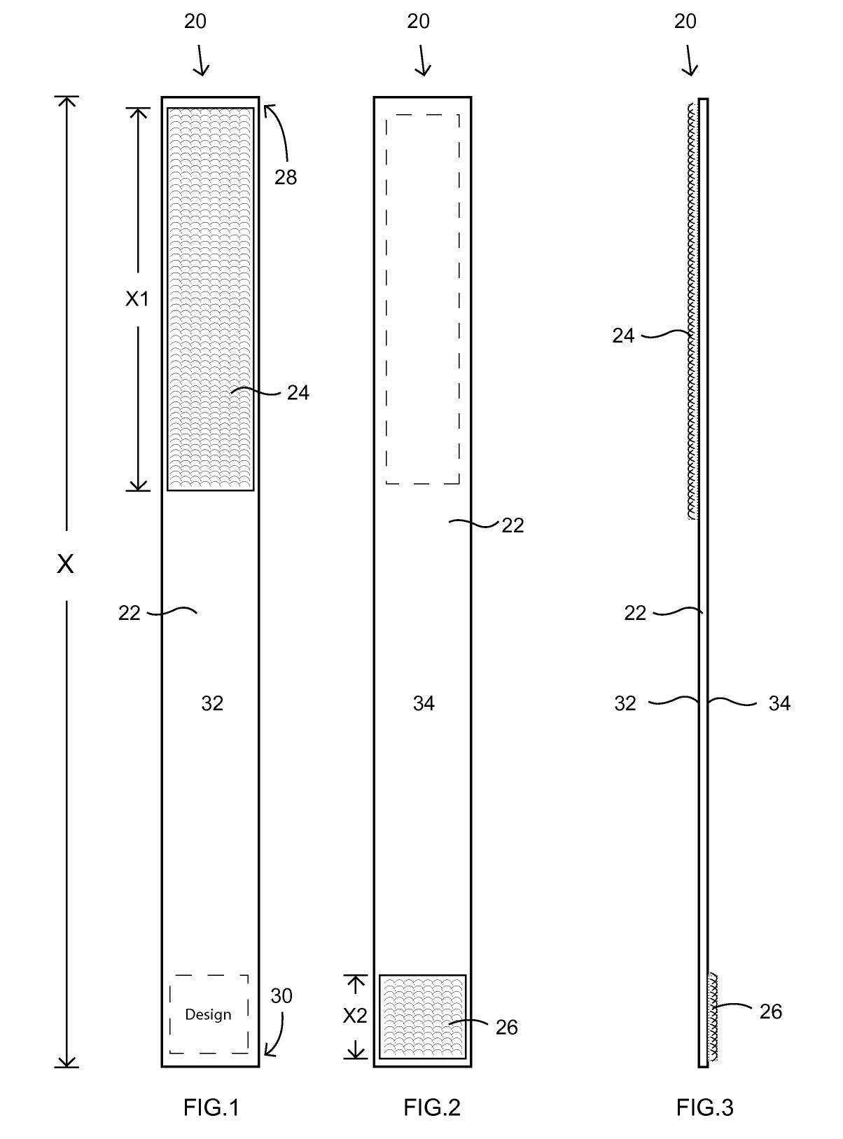

With initial reference to FIGS. 1-3, it will be seen that the exemplary apparatus 20 comprises a strap 22 and a pair of hook and loop fasteners 24, 26. The strap 22 has a thickness Z, a width Y greater than the thickness Z, a length X greater than the width Y, a pair of ends 28,30 spaced-apart lengthwise from one another and a pair of faces 32,34 spaced apart from one another in the direction of the thickness Z. One 24 of the pair of hook and loop fasteners 24,26 is disposed on one 32 of the pair of faces 32, 34 and adjacent one 28 of the pair of ends 28,30 and has a length X1; the other 26 of the pair of hook and loop fasteners 24,26 is disposed on the other 34 of the pair of faces 32,34 and adjacent the other 30 of the pair of ends 28,30 and has a length X2.

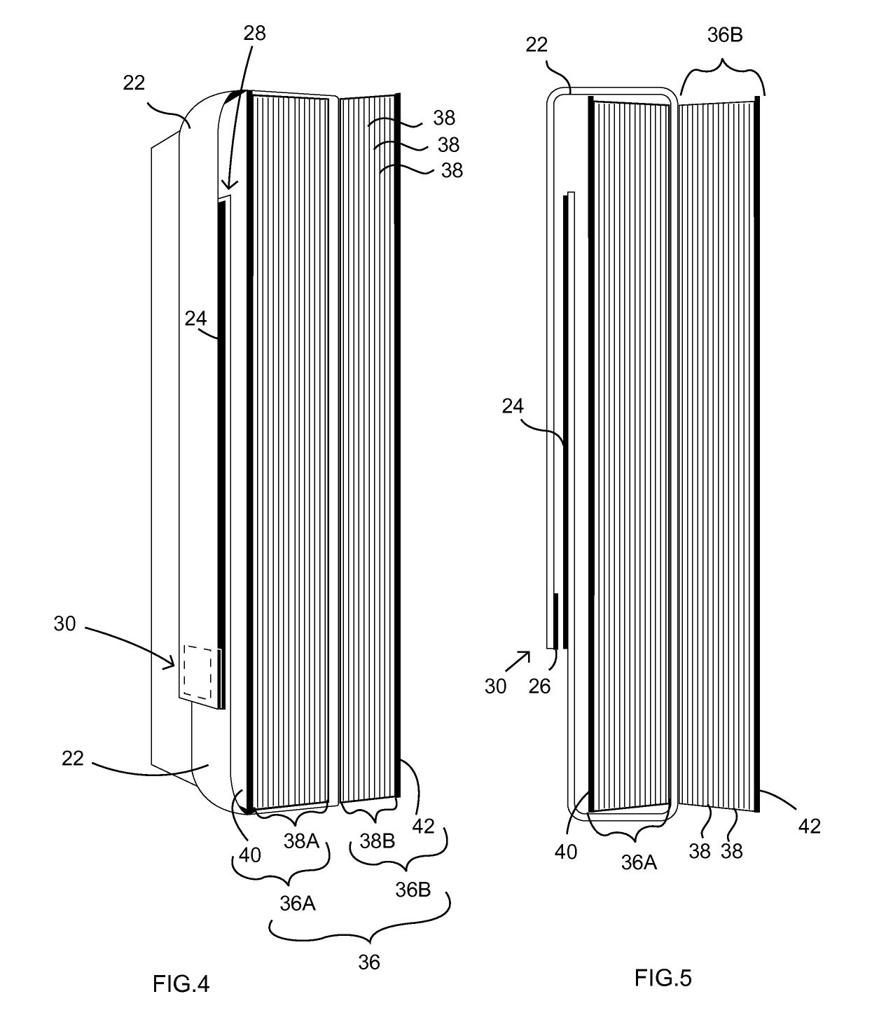

The apparatus is shown in use in FIG. 4 and FIG. 5, with a conventional book 36 of the type defined by a plurality of pages 38 and a pair of covers 40,42, bound together.

Herein it will be seen that the strap 22 is shaped and sized and the pair of hook and loop fasteners are shaped, sized and positioned to permit, when the book is divided in the manner in which a standard bookmark divides a book, i.e. into two portions 36A,36B, each including a respective one of the covers and a respective portion 38A,38B of the pages, the strap to be wrapped around one of the portions and the hook and loop fasteners to be releasably engaged together, such that said one of the portions is grippingly received by the strap and the location is reliably marked, without risk of damage to the book.

To achieve the aforementioned functionality in the context of typical 3″×5″ books, typical 4″×6″ books and typical 7″×7″ books, the apparatus can be provided in a format where X is 15.5″, X1 is 5″ and X2 is 1″.

To achieve the aforementioned functionality in the context of typical 7″×7″ books, typical 5″×8″ books and typical 6″×9″ books, the apparatus can be provided in a format wherein X is 21.75″, X1 is 7″ and X2 is 1″.

To achieve the aforementioned functionality in the context of typical 7″×10″ books, typical 8″×10″ books, typical 8.5″×11″ books and typical 9.5″×12″ books, the apparatus can be provided in a format wherein X is 27.5″, X1 is 7″ and X2 is 1″.

To achieve the aforementioned functionality in the context of typical 6″×9″ books, typical 7″×10″ books, typical 8″×10″ books, typical 8.5″×11″ books and typical 9.5″×12″ books, the apparatus can be provided in a format wherein X is 29.5″, X1 is 9″ and X2 is 1″.

In either format, a width Y between 1″ and 2″ has been proven useful, although broader and narrower widths can also be used.

It has been proven useful to construct the strap out of twill tape, in cotton, polyester and acrylic versions, but again, although fabrics can be used.

Although not shown, it should also be understood that the strap can be shaped and sized and the pair of hook and loop fasteners can be shaped, sized and positioned to permit, when it is desired to maintain the book in a closed position, the strap to be wrapped around the book and the hook and loop fasteners to be releasably engaged together, whereby the book is grippingly received by the strap to urge the covers together against the pages.

Whereas a specific embodiment is herein illustrated, and various specific sizes are shown, it will be understood that variation is possible.

Accordingly, the invention should be understood as limited only by the accompanying claims, purposively construed.

1. Apparatus for use with a plurality of pages and a pair of covers, the pages and covers being bound together to define a book, the apparatus comprising:
a strap having a thickness, a width greater than the thickness, a length greater than the width, a pair of ends spaced-apart lengthwise from one another and a pair of faces spaced apart a distance defined by the thickness;
a pair of hook and loop fasteners,
one of the pair being disposed on one of the faces and adjacent one of the ends; and
the other of the pair being disposed on the other of the faces and adjacent the other of the ends,
the strap being shaped and sized and the pair of hook and loop fasteners being shaped, sized and positioned to permit, when it is desired to bookmark a location in the book and thereby notionally divide the book into two portions, each including a respective one of the covers and a respective portion of the plurality of pages,
the strap to be wrapped around one of the portions and
the hook and loop fasteners to be releasably engaged together,
whereby the one of the portions is grippingly received by the strap and the location is marked.

2. Apparatus according to claim 1, wherein
the length is about 15.5 inches,
the one of the hook and loop fasteners is about 5 inches in length, and
the other of the hook and loop fasteners is about 1 inch in length.

3. Apparatus according to claim 1, wherein
the length is about 21.75 inches,
the one of the hook and loop fasteners is about 7 inches in length, and
the other of the hook and loop fasteners is about 1 inch in length.

4. Apparatus according to claim 1, wherein
the length is about 27.5 inches,
the one of the hook and loop fasteners is about 7 inches in length, and
the other of the hook and loop fasteners is about 1 inch in length.

5. Apparatus according to claim 1, wherein
the length is about 29.5 inches,
the one of the hook and loop fasteners is about 9 inches in length, and
the other of the hook and loop fasteners is about 1 inch in length.

6. Apparatus according to claim 1, wherein the width is between 1 inch and 2 inches.

7. Apparatus according to claim 2, wherein the width is between 1 inch and 2 inches.

8. Apparatus according to claim 3, wherein the width is between 1 inch and 2 inches.

9. Apparatus according to claim 4, wherein the width is between 1 inch and 2 inches.

10. Apparatus according to claim 5, wherein the width is between 1 inch and 2 inches.

11. Apparatus according to claim 1, wherein the strap is constructed from twill tape.

12. Apparatus according to claim 2, wherein the strap is constructed from twill tape.

13. Apparatus according to claim 3, wherein the strap is constructed from twill tape.

14. Apparatus according to claim 4, wherein the strap is constructed from twill tape.

15. Apparatus according to claim 5, wherein the strap is constructed from twill tape.
